(19) United States
(12) Patent Application Publication
(10) Pub. No.: US 2013/0140961 A1
(43) Pub. Date: Jun. 6, 2013

(54) SPINDLE MOTOR AND METHOD OF MANUFACTURING THE SAME

(71) Applicants: Yong Sik KIM, Hwaseong (KR); Il Oung Park, Seoul (KR); Ho Hyung Jang, Suwon (KR)

(72) Inventors: Yong Sik KIM, Hwaseong (KR); Il Oung Park, Seoul (KR); Ho Hyung Jang, Suwon (KR)

(73) Assignee: SAMSUNG ELECTRO-MECHANICS CO., LTD., Suwon (KR)

(21) Appl. No.: 13/616,754

(22) Filed: Sep. 14, 2012

(30) Foreign Application Priority Data
Dec. 5, 2011 (KR) 10-2011-0129017

(51) Int. Cl. H02K 19/02; H02K 15/00

(52) U.S. Cl. 310/40 R; 156/73.1

(57) ABSTRACT

There is provided a spindle motor including: a sleeve rotatably supporting a shaft; a cover member installed on a lower end portion of the sleeve; and a bonding member disposed between the sleeve and the cover member such that the cover member is installed on the sleeve and formed of an anisotropic conductive material.

### CROSS-REFERENCE TO RELATED APPLICATIONS

This application claims the priority of Korean Patent Application No. 10-2011-0129017 filed on Dec. 5, 2011, in the Korean Intellectual Property Office, the disclosure of which is incorporated herein by reference.

### BACKGROUND OF THE INVENTION

1. Field of the Invention

The present invention relates to a spindle motor and a method of manufacturing the same.

2. Description of the Related Art

A small-sized spindle motor used for a hard disk drive (HDD) generally includes a fluid dynamic pressure bearing assembly, and a bearing clearance provided in the fluid dynamic pressure bearing assembly is filled with a lubricating fluid.

In addition, at the time of rotation of a shaft, the lubricating fluid filling the bearing clearance is pumped to form fluid dynamic pressure, thereby rotatably supporting the shaft.

Meanwhile, in order to prevent the lubricating fluid filling the fluid dynamic pressure bearing assembly from leaking, a cap member and a cover member are installed on an upper end portion and a lower end portion of a sleeve, respectively.

In addition, the cap member and the cover member are installed on and bonded to the sleeve by welding or an adhesive formed of a resin material.

However, in the case in which the cap member and the cover member are installed on and bonded to the sleeve by the welding, thermal deformation may be generated in the cap member, the cover member, and the sleeve, due to heat caused by the welding.

In addition, the cap member and the cover member may not be completely installed at the time of the generation of the thermal deformation, that is, an excessive amount of welding may be generated or welding may not occur in a portion to be welded, such that lubricating fluid may be leaked.

Further, it may be difficult to confirm these welding defects with the naked eye, such that a process of confirming a welded state of the cap member and the cover member may be additionally required in a subsequent process, thereby reducing a manufacturing yield.

Meanwhile, in the case in which the cap member and the cover member are installed on and bonded to the sleeve by the adhesive formed of a resin material, it may take a long time to melt and harden the adhesive, thereby reducing a manufacturing yield.

Furthermore, in the case in which the cap member and the cover member are installed on and bonded to the sleeve by the adhesive, bonding force between the cap member and the sleeve and between the cover member and the sleeve may be weak, such that the cap member and the sleeve may be separated from the sleeve at the time of an external impact.

### SUMMARY OF THE INVENTION

An aspect of the present invention provides a spindle motor capable of suppressing deformation of a portion thereof in which a sleeve and a cover member or the sleeve and a cap member are bonded to each other, and preventing the cover member and the cap member from being separated from the sleeve.

Another aspect of the present invention provides a method of manufacturing a spindle motor capable of improving a manufacturing yield thereof.

According to an aspect of the present invention, there is provided a spindle motor including: a sleeve rotatably supporting a shaft; a cover member installed on a lower end portion of the sleeve; and a bonding member disposed between the sleeve and the cover member such that the cover member is installed on the sleeve and formed of an anisotropic conductive material.

The bonding member may be formed of an anisotropic conductive film (ACF) so as to suppress deformation of the cover member and the sleeve.

The spindle motor may further include a cap member installed on an upper end portion of the sleeve and an adhering member disposed between the cap member and the sleeve and formed of an ACF.

The bonding member and the adhering member may be melted with ultrasonic waves and then hardened, such that the cover member and the cap member are installed on the sleeve.

Each of the adhering member and the bonding member, formed of the ACF, may include a film layer, a resin layer stacked on the film layer, and conductive particles contained in the resin layer.

According to another aspect of the present invention, there is provided a method of manufacturing a spindle motor, the method including: disposing a bonding member between a sleeve and a cover member; and fixedly installing the cover member on the sleeve by melting the bonding member with ultrasonic waves and then hardening the melted bonding member.

The method may further include, after the installing of the cover member on the sleeve, seating a cap member on an upper portion of the sleeve and disposing an adhering member between the sleeve and the cap member; and fixedly installing the cap member on the sleeve by melting the adhering member with the ultrasonic waves and then hardening the melted adhering member.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is an enlarged view showing part A of FIG. 1;

FIG. 3 is an enlarged view showing part B of FIG. 1; and

FIG. 4 is an enlarged view showing a configuration of a bonding member provided in the spindle motor according to the embodiment of the present invention; and

FIG. 5 is a flow chart showing a method of manufacturing a spindle motor according to an embodiment of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, when it is determined that the detailed description of the known art related to the present invention may obscure the gist of the present invention, the detailed description thereof will be omitted.

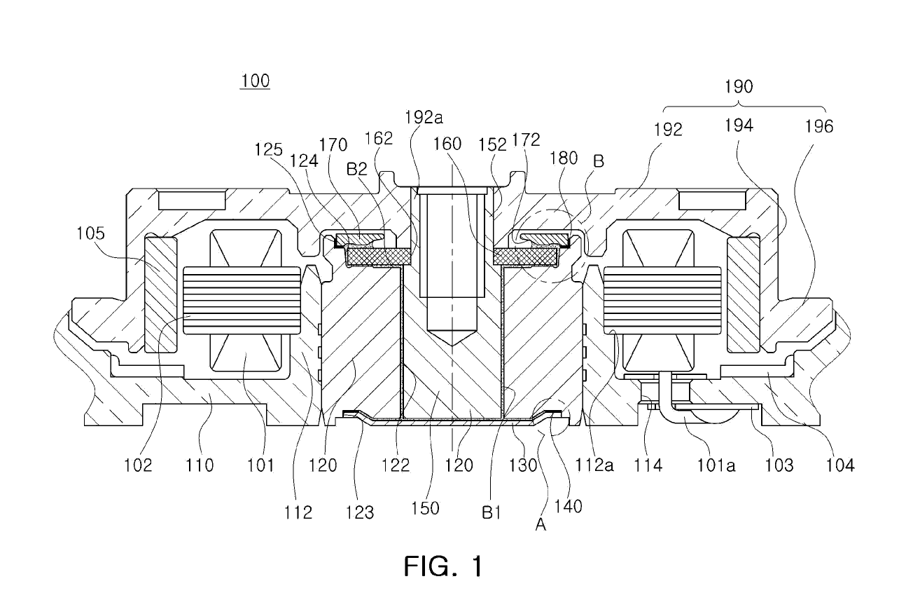

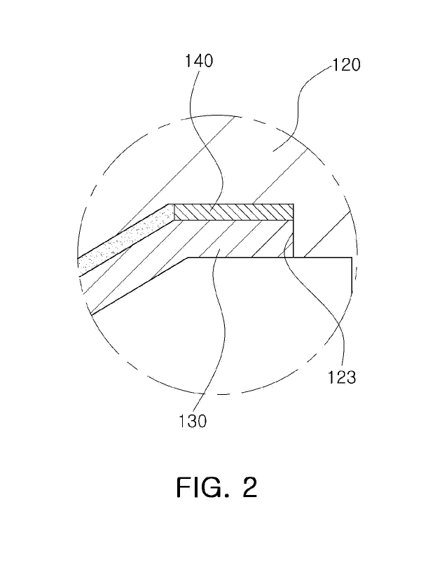

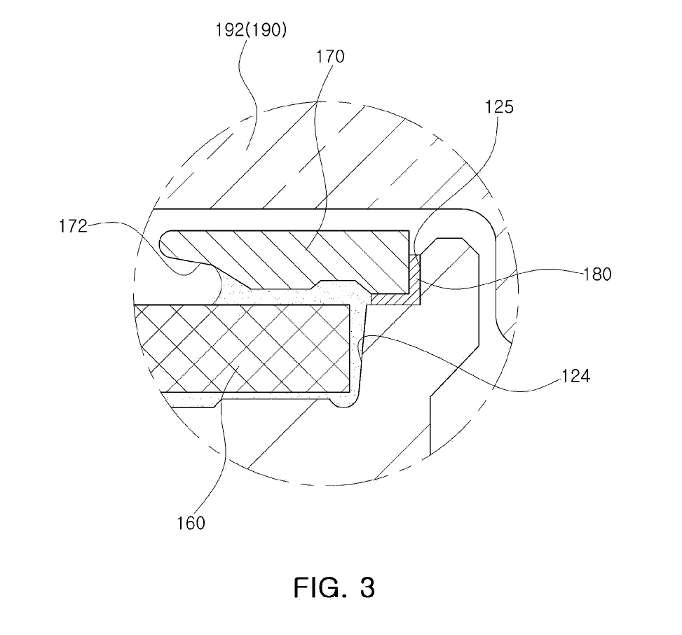

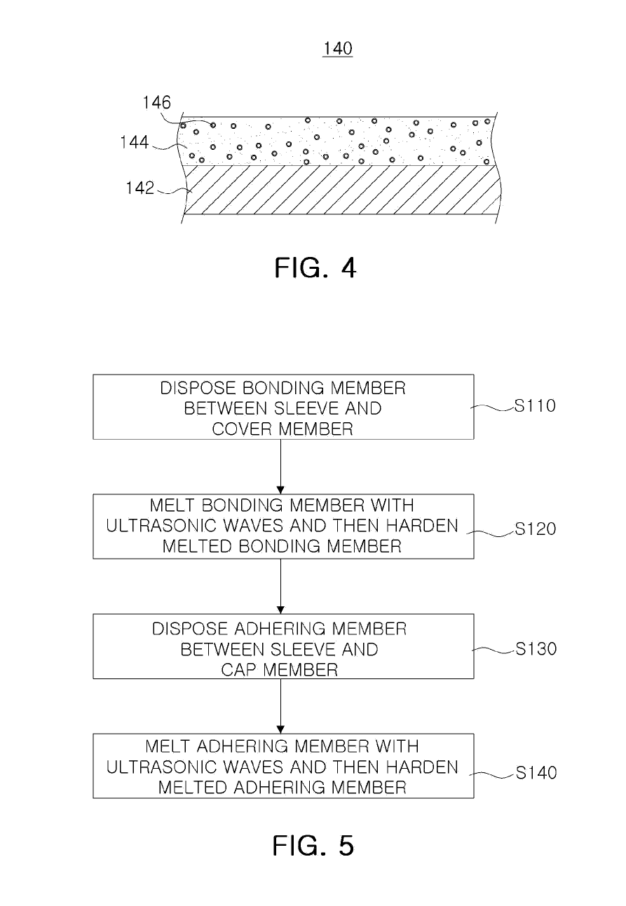

FIG. 1 is a schematic cross-sectional view showing a spindle motor according to an embodiment of the present invention; FIG. 2 is an enlarged view showing part A of FIG. 1; FIG. 3 is an enlarged view showing part B of FIG. 1; and FIG. 4 is an enlarged view showing a configuration of a bonding member provided in the spindle motor according to the embodiment of the present invention.

Referring to FIGS. 1 through 4, a spindle motor 100 according to the embodiment of the present invention may include a base member 110, a sleeve 120, a cover member 130, a bonding member 140, a shaft 150, a thrust plate 160, a cap member 170, an adhering member 180, and a rotor hub 190 by way of example.

Meanwhile, the spindle motor 100 may be a motor used in a hard disk drive driving a recoding disk.

Here, terms with respect to directions will be defined. As viewed in FIG. 1, an axial direction refers to a vertical direction, that is, a direction from an upper portion of the shaft 150 toward a lower portion thereof or a direction from the lower portion of the shaft 150 toward the upper portion thereof, and a radial direction refers to a horizontal direction, that is, a direction from an outer peripheral surface of the rotor hub 190 toward the shaft 150 or a direction from the shaft 150 toward the outer peripheral surface of the rotor hub 190.

In addition, a circumferential direction refers to a rotation direction along the outer peripheral surface of the rotor hub 190.

The base member 110 may include a protrusion part 112 having the sleeve 120 inserted therein. The protrusion part 112 may be protruded upwardly in the axial direction and have a hollow cylindrical shape. In addition, the sleeve 120 may be inserted into the protrusion part 112.

Further, the protrusion part 112 may include a stator core 102 installed on an outer peripheral surface thereof, wherein the stator core 102 has a coil 101 wound therearound. That is, the stator core 102 may be fixedly installed on the protrusion part 112 by an adhesive and/or welding in a state in which it is seated on a seat surface 112a formed on the outer peripheral surface of the protrusion part 112.

In addition, the base member 110 may include a lead hole 114 formed therein so as to be disposed in the vicinity of the protrusion part 112. In addition, a lead part 101a of the coil 101 wound around the stator core 102 may be led from an upper portion of the base member 110 toward a lower portion thereof through the lead hole 114.

Meanwhile, a lower surface of the base member 110 may be provided with a circuit board 103 to which the lead part 101a of the coil 101 is bonded. In addition, the circuit board 103 may be a flexible circuit board.

In addition, the base member 110 may include a pulling plate 104 installed thereon in order to prevent the rotor hub 190 from being excessively floated, wherein the pulling plate 104 may have an annular ring shape.

The sleeve 120 may rotatably support the shaft 150. In addition, the sleeve 120 may be inserted into and fixed to the protrusion part 112 as described above. That is, an outer peripheral surface of the sleeve 120 may be bonded to an inner peripheral surface of the protrusion part 112 by an adhesive.

However, the sleeve 120 is not limited to being bonded to the protrusion part 112 by the adhesive, but may also be press-fitted into the protrusion part 112 or be bonded to the protrusion part 112 by welding.

Further, the sleeve 120 may include a shaft hole 122 formed therein such the shaft 130 may be inserted therein. That is, the sleeve 120 may have a hollow cylindrical shape.

Meanwhile, in the case in which the shaft 130 is inserted in the sleeve 120, an inner peripheral surface of the sleeve 120 and an outer peripheral surface of the shaft 130 may be spaced apart from each other by a predetermined interval to thereby form a bearing clearance B1 therebetween. This bearing clearance B1 may be filled with a lubricating fluid.

In addition, the sleeve 120 may include a dynamic pressure groove (not shown) formed in an inner surface thereof so as to generate fluid dynamic pressure by pumping the lubricating fluid filling the bearing clearance B1 at the time of rotation of the shaft 130.

Further, the sleeve 120 may include the cover member 130 installed on a lower end portion thereof in order to prevent the lubricating fluid filling the bearing clearance B1 from being leaked downwardly. That is, the sleeve 120 may include a depression groove 123 depressed upwardly at the lower end portion thereof so that the cover member 130 may be installed therein.

In addition, the sleeve 120 may have an insertion groove 124 formed in an upper end portion thereof, wherein the insertion groove 124 has the thrust plate 160 inserted therein. The insertion groove 124 may have a shape corresponding to that of the thrust plate 160.

In addition, the sleeve 120 may include the cap member mounting part 125 formed at the upper end portion thereof, wherein the cap member mounting part 125 is disposed outwardly of the insertion groove 124 in the radial direction. The cap member mounting part 125 may be formed in the sleeve 120 so as to be disposed outwardly of the insertion groove 124 in the radial direction and may be disposed in a position higher than that of the insertion groove 124. That is, the cap member mounting part 125 and the insertion groove 124 may form a step part.

The cover member 130 may be installed on the lower end portion of the sleeve 120. That is, the cover member 130 may be installed in the depression groove 123 formed at the lower end portion of the sleeve 120.

In addition, the cover member 130 may serve to prevent the lubricating fluid filling the bearing clearance B1 described above from being leaked downwardly of the sleeve 120. That is, the cover member 130 may have a circular plate shape and enclose a lower portion of the shaft hole 122 of the sleeve 120.

The bonding member 140 may be disposed between the sleeve 120 and the cover member 130 so that the cover member 130 is installed on the sleeve 120 and may be formed of an anisotropic conductive material. That is, the bonding member 140 may serve to fixedly install the cover member 130 on the sleeve 120.

In addition, the bonding member 140 may be formed of an anisotropic conductive film (ACF) so as to suppress deformation of the cover member 130 and the sleeve 120.

Here, a method of fixedly installing the cover member 130 on the sleeve 120 by the bonding member 140 will be described in detail.

First, the cover member 130 is stacked on an upper portion of the bonding member 140 in a state in which the bonding member 140 formed of the anisotropic conductive film is seated in the depression groove 123 of the sleeve 120.

Then, ultrasonic waves generated from an ultrasonic wave generator may pass through the cover member 130 to be transferred to the bonding member 140.

Therefore, the bonding member 140 is melted and then hardened, such that the cover member 130 may be fixed into the depression groove 123 of the sleeve 120.

As described above, the ultrasonic waves may be transferred to the bonding member 140 formed of the anisotropic conductive film (ACF) to thereby allow a bonding process to be performed. Therefore, the bonding process may be performed within about 5 seconds. That is, the bonding process may be more rapidly performed.

In addition, since the cover member 130 may be installed on the sleeve 120 by melting the bonding member 140 with the ultrasonic waves and hardening the melted bonding member 140, generation of thermal deformation may be suppressed and generation of contamination may be prevented in advance.

Further, bonding force between the cover member 130 and the sleeve 120 may be improved as compared to a case in which the cover member 130 is installed on the sleeve 120 by welding or an adhesive.

Furthermore, as shown in FIG. 4, the bonding member 140 includes a film layer 142, a resin layer 144 stacked on the film layer 142, and conductive particles 146 contained in the resin layer 144. Thus, at the time of melting of the bonding member 140, the conductive particles 146 are widely spread, such that the bonding member 140 may have conductivity.

Therefore, when a conductive bond is applied to a bonding portion between the base member 110 and the sleeve 120 in a subsequent process, even in the case in which an application amount of conductive bond is reduced, the sleeve 120, the cover member 130, and the base member 110 may be more securely electrically connected to each other.

The shaft 150 may be rotatably inserted in the sleeve 120. That is, the shaft 150 may be inserted in the shaft hole 122 of the sleeve 120.

In addition, the shaft 150 may include an installation part 152 on which the thrust plate 160 and the rotor hub 190 are installed. That is, the shaft 150 may include the installation part 152 provided at an upper end portion thereof, wherein the installation portion 152 has the thrust plate 160 and the rotor hub 190 installed thereon and allows the upper end portion of the shaft 150 to have a diameter smaller than that of a lower end portion thereof.

The thrust plate 160 may be fixedly installed on the shaft 150 to thereby rotate together with the shaft 150. That is, the thrust plate 160 may be fixedly installed on the installation part 152 of the shaft 150. To this end, the thrust plate 160 may have a circular ring shape provided with an installation hole 162 so as to allow the shaft 150 to penetrate therethrough.

Meanwhile, the thrust plate 160 may be inserted in the insertion groove 124 of the sleeve 120, and a bottom surface of the insertion groove 124 and a lower surface of the thrust plate 160 may be disposed to be spaced apart from each other at a predetermined interval to thereby form a bearing clearance B2.

In addition, a thrust dynamic pressure groove (not shown) may be formed in at least one of the lower surface of the thrust plate 160 and the bottom surface of the insertion groove 124 in order to generate thrust fluid dynamic pressure at the time of rotation of the shaft 150.

That is, in the case in which the thrust plate 160 rotates together with the shaft 150, force directed upwardly in the axial direction may be generated by the thrust dynamic pressure groove, such that the rotor hub 190 may be floated at a predetermined height.

The cap member 170 may be fixedly installed on the sleeve 120, and the cap member 170 and the thrust plate 160 may form a liquid-vapor interface between the lubricating fluid and air. That is, the cap member 170 may be fixedly installed on the cap member mounting part 125 to thereby serve to form the liquid-vapor interface with the thrust plate 160.

In addition, the cap member 170 may have an inclined surface 172 provided at a lower surface thereof so as to form the liquid-vapor interface with the thrust plate 160. The inclined surface 172 may be adjacent to an inner diameter portion on the lower surface of the cap member 170.

The adhering member 180 may be disposed between the sleeve 120 and the cap member 170 so that the cap member 170 is installed on the sleeve 120 and may be formed of an anisotropic conductive material. That is, the adhering member 180 may serve to fixedly install the cap member 170 on the sleeve 120.

In addition, the adhering member 180 may be formed of an anisotropic conductive film (ACF) so as to suppress deformation of the cap member 170 and the sleeve 120.

Here, a method of installing the cap member 170 on the sleeve 120 by the adhering member 180 will be described in detail.

First, the cap member 170 is disposed in the cap member mounting part 125 in a state in which the adhering member 180 formed of the anisotropic conductive film is disposed on a bottom surface of the cap member mounting part 125 of the sleeve 120 and a sidewall of the cap member mounting part 125 of the sleeve 120.

Then, ultrasonic waves generated from an ultrasonic wave generator may be transferred to the adhering member 180.

Therefore, the adhering member 180 is melted and then hardened, such that the cap member 170 may be fixed in the cap member mounting part 125 of the sleeve 120.

As described above, the ultrasonic waves may be transferred to the adhering member 180 formed of the anisotropic conductive film (ACF), to thereby allow a bonding process to be performed. Therefore, the bonding process may be performed within about 5 seconds. That is, the bonding process may be more rapidly performed.

In addition, since the cap member 170 may be installed on the sleeve 120 by melting the adhering member 180 with the ultrasonic waves and hardening the melted adhering member 180, generation of thermal deformation may be suppressed and generation of contamination may be prevented in advance.

Further, bonding force between the cap member 170 and the sleeve 120 may be improved as compared to a case in which the cap member 170 is installed on the sleeve 120 by welding or an adhesive.

The rotor hub 190 may be installed on the installation part 152 so as to be disposed above the thrust plate 160. In addition, the rotor hub 190 may include a body 192 provided with an mounting hole 192a into which the installation part 152 of the shaft 150 is inserted, a magnet mounting part 194 extended downwardly from an edge of the body 192 in the axial direction, and a disk mounting part 196 extended from the magnet mounting part 194 outwardly in the radial direction.

The magnet mounting part 194 may have a magnet 105 installed on an inner surface thereof, wherein the magnet 105 is disposed to face a front end of the stator core 102 having the coil 101 wound around.

Meanwhile, the magnet 105 may have an annular ring shape and be a permanent magnet generating magnetic force having a predetermined strength by alternately magnetizing an N pole and an S pole in the circumferential direction.

Here, rotational driving of the rotor hub 190 will be schematically described. When power is supplied to the coil 101 wound around the stator core 102, driving force capable of rotating the rotor hub 190 may be generated by electromagnetic interaction between the magnet 105 and the stator core 102 having the coil 101 wound therearound.

Therefore, the rotor hub 190 rotates, such that the shaft 150 to which the rotor hub 190 is fixedly coupled may rotate together with the rotor hub 190.

As described above, the cover member 130 and the cap member 170 are installed on the sleeve 120 by melting the bonding member 140 and the adhering member 180 each formed of the anisotropic conductive film with the ultrasonic waves and then hardening the melted bonding member 140 and adhering member 180, whereby the deformation of the sleeve 130, the cover member 130, and the cap member 170 due to heat may be suppressed.

In addition, the bonding force between the sleeve 120 and the cover member 130 and the bonding force between the sleeve 120 and the cap member 170 may be improved, whereby separation of the cover member 130 and the cap member 170 from the sleeve 120 may be prevented.

Further, an application amount of a conductive bond may be reduced through the bonding member 140 formed of the anisotropic conductive film (ACF).

In addition, the cover member 130 and the cap member 170 are installed on the sleeve 120 by the bonding member 140 and the adhering member 180 each formed of the anisotropic conductive film, whereby a process time may be reduced.

Hereinafter, a method of manufacturing a spindle motor according to an embodiment of the present invention will be described with reference to the accompanying drawings. However, the same reference numerals will be used to describe the same components as the above-mentioned components. That is, further referring to FIGS. 1 through 4, a method of manufacturing a spindle motor according to an embodiment of the present invention will be described.

FIG. 5 is a flow chart showing a method of manufacturing a spindle motor according to an embodiment of the present invention.

Referring to FIG. 5, the method of manufacturing a spindle motor according to the embodiment of the present invention may include disposing the bonding member 140 between the sleeve 120 and the cover member 130 (S110), and installing the cover member 130 on the sleeve 120 by melting the bonding member 140 with ultrasonic waves and then hardening the melted bonding member 140 (S120).

First, the sleeve 120 may be prepared by a manufacturer in such a manner that the lower end portion thereof is positioned upwardly. Then, the bonding member 140 is seated on the depression groove 123 formed in the lower end portion of the sleeve 120.

Next, the cover member 130 is seated by the manufacturer in such a manner that the cover member 130 is disposed on the bonding member 140.

Then, an ultrasonic wave generator is disposed above the cover member 130, such that ultrasonic waves may be generated from the ultrasonic wave generator.

Therefore, the ultrasonic waves are transferred to the bonding member 140, such that the bonding member 140 is melted and then hardened, whereby the cover member 130 may be fixedly installed on the sleeve 120.

As described above, since the cover member 130 may be installed on the sleeve 120 through the ultrasonic wave, a processing time may be reduced. Therefore, a manufacturing yield may be improved.

That is, a time required for melting and hardening the bonding member 140 is reduced as compared to a case in which an adhesive is applied, whereby the manufacturing yield may be improved.

In addition, since the cover member 130 is installed on the sleeve 120 with the ultrasonic waves, thermal deformation of the cover member 130 and the sleeve 120 may be suppressed. Therefore, a process of inspecting an installation defect due to the thermal deformation of the cover member 130 and the sleeve 120 may be omitted in a subsequent process.

Therefore, the manufacturing yield may be further improved.

In addition, when a conductive bond is applied to a bonding portion between the base member 110 and the sleeve 120 in a subsequent process, even in the case in which an application amount of conductive bond is reduced, the sleeve 120, the cover member 130, and the base member 110 may be more surely electrically connected to each other.

Therefore, since the application amount of conductive bond may be reduced, a manufacturing cost may be reduced.

Meanwhile, the method of manufacturing a spindle motor according to the embodiment of the present invention may further include, after installing the cover member 130 on the sleeve 120 by melting the bonding member 140 with the ultrasonic waves and then hardening the melted bonding member 140 (S120), seating the cap member 170 on the upper portion of the sleeve 120 and disposing the adhering member 180 between the sleeve 120 and the cap member 170 (S130), and fixedly installing the cap member 170 on the sleeve 120 by melting the adhering member 180 with the ultrasonic waves and then hardening the melted adhering member 180 (S140).

In addition, before disposing the adhering member 180 between the sleeve 120 and the cap member 170 (S130), the shaft 150 to which the thrust plate 160 is fixed may be inserted in the shaft hole 122 of the sleeve 120.

Then, the adhering member 180 may be disposed on the bottom surface of the cap member mounting part 125 of the sleeve 120 and the sidewall of the cap member mounting part 125 of the sleeve 120. Then, the cap member 170 may be seated on the cap member mounting part 125.

Then, the ultrasonic wave generator may be disposed on an upper portion of the cap member 170, such that the ultrasonic waves are generated from the ultrasonic wave generator.

Therefore, the ultrasonic waves are transferred to the adhering member 180, such that the adhering member 180 is melted and then hardened, whereby the cap member 170 may be fixedly installed on the sleeve 120.

As described above, since the cap member 170 may be installed on the sleeve 120 with the ultrasonic wave, a processing time may be reduced. Therefore, a manufacturing yield may be improved.

In addition, since the cap member 170 is installed on the sleeve 120 with the ultrasonic wave, thermal deformation of the cap member 170 and the sleeve 120 may be suppressed. Therefore, a process of inspecting an installation defect due to the thermal deformation of the cap member 170 and the sleeve 120 may be omitted in a subsequent process. Therefore, the manufacturing yield may be further improved.

As described above, the cover member 130 and the cap member 170 are installed on the sleeve 120 by melting the bonding member 140 and the adhering member 180 with the ultrasonic waves and then hardening the melted bonding member 140 and adhering member 180 (S120 and S140), whereby the manufacturing yield may be improved.

As set forth above, according to the embodiments of the present invention, the cover member and the cap member are installed on the sleeve by melting the bonding member and the adhering member each formed of an anisotropic conductive film with the ultrasonic waves and then hardening the melted bonding member and adhering member, whereby deformation at a bonded portion due to the heat may be suppressed.

In addition, the bonding force between the sleeve and the cover member and the bonding force between the sleeve and the cap member is improved, whereby the separation of the cover member and the cap member from the sleeve can be prevented.

Further, the application amount of conductive bond can be reduced through the bonding member formed of the anisotropic conductive film.

Furthermore, the cover member and the cap member are installed on the sleeve by the bonding member and the adhering member each formed of the anisotropic conductive film, whereby a process time may be reduced.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a sleeve rotatably supporting a shaft;
a cover member installed on a lower end portion of the sleeve; and
a bonding member disposed between the sleeve and the cover member such that the cover member is installed on the sleeve and formed of an anisotropic conductive material.

2. The spindle motor of claim 1, wherein the bonding member is formed of an anisotropic conductive film (ACF) so as to suppress deformation of the cover member and the sleeve.

3. The spindle motor of claim 1, further comprising a cap member installed on an upper end portion of the sleeve and an adhering member disposed between the cap member and the sleeve and formed of an ACF.

4. The spindle motor of claim 3, wherein the bonding member and the adhering member are melted with ultrasonic waves and then hardened, such that the cover member and the cap member are installed on the sleeve.

5. The spindle motor of claim 3, wherein each of the adhering member and the bonding member, formed of the ACF, includes a film layer, a resin layer stacked on the film layer, and conductive particles contained in the resin layer.

6. A method of manufacturing a spindle motor, the method comprising:
disposing a bonding member between a sleeve and a cover member; and
fixedly installing the cover member on the sleeve by melting the bonding member with ultrasonic waves and then hardening the melted bonding member.

7. The method of claim 6, wherein the bonding member is formed of ACF so as to suppress deformation of the cover member and the sleeve.

8. The method of claim 6, further comprising, after the installing of the cover member on the sleeve,
seating a cap member on an upper portion of the sleeve and disposing an adhering member between the sleeve and the cap member; and
fixedly installing the cap member on the sleeve by melting the adhering member with the ultrasonic waves and then hardening the melted adhering member.

9. The method of claim 8, wherein the adhering member is formed of an ACF so as to suppress deformation of the cap member and the sleeve.

10. The method of claim 6, wherein the adhering member formed of an ACF includes a film layer, a resin layer stacked on the film layer, and conductive particles contained in the resin layer.
